(19) United States
(12) Patent Application Publication
(10) Pub. No.: US 2011/0076563 A1
(43) Pub. Date: Mar. 31, 2011

(54) POSITIVE ELECTRODE FOR NON-AQUEOUS ELECTROLYTE SECONDARY BATTERY AND METHOD FOR PRODUCING THE SAME

(76) Inventors: Kaoru NAGATA, Osaka (JP); Yoshiyuki Muraoka, Osaka (JP)

(21) Appl. No.: 12/891,270

(22) Filed: Sep. 27, 2010

(30) Foreign Application Priority Data
Sep. 29, 2009 (JP) 2009-223623

(51) Int. Cl. H01M 4/58; H05H 1/24; B05D 5/12

(52) U.S. Cl. 429/231.1; 427/576

(57) ABSTRACT

A positive electrode for a non-aqueous electrolyte secondary battery includes a current collector including Al, and a positive electrode active material layer adhering to the current collector. The positive electrode active material layer includes a composite oxide containing Li and a transition metal element Me. The positive electrode active material layer has, at least on the current collector side, a region in which Al is diffused from the current collector.

### FIELD OF THE INVENTION

The invention relates to a positive electrode for a non-aqueous electrolyte secondary battery, and particularly to an improvement in a positive electrode active material layer.

### BACKGROUND OF THE INVENTION

Recently, electronic devices such as personal computers and cellular phones are increasingly becoming mobile. As the power source for such electronic devices, there is demand for high capacity secondary batteries that are small and light-weight. This has lead to extensive developments of non-aqueous electrolyte secondary batteries capable of providing high energy density.

To further heighten the energy density of non-aqueous electrolyte secondary batteries, high capacity active materials are being developed. Also, various attempts are being made to increase the active material density (packing rate) of electrodes. For example, it has been proposed to deposit an active material on a current collector surface without using a conductive agent or binder, in order to form a dense active material layer.

Patent Document 1 (International Publication No. WO 01/029913) proposes an active material thin film comprising an amorphous silicon (Si) thin film with a composition gradient in the thickness direction. Patent Document 1 discloses, as an example of such composition gradient, a negative electrode in which the content of a current collector component (Cu, Fe, etc.) diffused in the active material thin film is changed. Such configuration is believed to increase the bonding strength between the active material thin film and the current collector.

Patent Document 2 (Japanese Laid-Open Patent Publication No. 2008-152925) proposes a secondary battery comprising a binder-free positive electrode, a solid electrolyte, and a binder-free negative electrode, wherein the composition of the portion of the solid electrolyte in contact with the positive electrode and the composition of the portion of the solid electrolyte in contact with the negative electrode are different. Such configuration is believed to provide a solid electrolyte battery which has good rate characteristics even at low temperatures.

Patent Document 3 (Japanese Laid-Open Patent Publication No. 2008-277242) proposes an electrode for a lithium secondary battery in which the active material layer has slit- or grid-like grooves in the surface. Such configuration is believed to increase the contact area between the active material and the electrolyte, thereby improving the rate characteristics.

### BRIEF SUMMARY OF THE INVENTION

The negative electrode as described in Patent Document 1 expands and contracts significantly due to charge/discharge. Thus, it is effective to diffuse an element (Cu, Fe, etc.) in the current collector into the active material layer, so as to increase the bonding strength between the current collector and the active material layer and change the composition of the active material layer near the current collector so that its expansion and contraction are reduced. However, to sufficiently diffuse an element in the current collector into the active material layer, the current collector needs to include an element which can be alloyed with Si, such as Cu.

In Patent Document 2, repeated charge/discharge decreases the bonding strength between the active material layer and the current collector, thereby promoting the separation of the active material from the current collector.

As in Patent Document 3, the formation of slits in the active material layer may improve rate characteristics, but cannot prevent the bonding strength between the active material layer and the current collector from decreasing due to repeated charge/discharge.

The use of a thermal plasma is effective for depositing an active material on a current collector surface without using a conductive agent or binder. Since the thermal plasma has a very high temperature, it allows an active material to be deposited on a current collector surface at a high deposition rate, compared with vapor deposition and sputtering. Thus, a high battery capacity can be realized at a high deposition rate.

However, when a positive electrode is produced by using a current collector including Al whose heat resistance is relatively low, the use of a high temperature thermal plasma is considered difficult. Further, when a composite oxide containing a transition metal element is used as a positive electrode active material, it is difficult to crystallize the active material, and a sufficient capacity cannot be obtained. If the positive electrode is heated at a high temperature to promote crystallization, the current collector may deteriorate, thereby causing the bonding strength between the active material layer and the current collector to decrease significantly.

It is therefore an object of the invention to provide a positive electrode which allows a non-aqueous electrolyte secondary battery to have high bonding strength between an Al-containing current collector and an active material layer and a high battery capacity.

One aspect of the invention relates to a positive electrode for a non-aqueous electrolyte secondary battery, including: a current collector including Al; and a positive electrode active material layer adhering to the current collector. The positive electrode active material layer includes a composite oxide containing Li and a transition metal element Me. The positive electrode active material layer has, at least on the current collector side, a region in which Al is diffused from the current collector.

Also, another aspect of the invention relates to a method for producing a positive electrode for a non-aqueous electrolyte secondary battery, including the steps of:

(a) generating a thermal plasma in a predetermined atmosphere;

(b) supplying a raw material of an active material into the thermal plasma;

(c) producing active material particles from the raw material in the thermal plasma; and

(d) depositing the active material particles produced in the thermal plasma onto a surface of a current collector in the predetermined atmosphere to form an active material layer.

The raw material includes Li and a transition metal element Me, and the current collector includes Al. The temperature of the current collector in the step (d) is controlled at 450° C. or more and less than 600° C.

The invention can provide a positive electrode which allows a non-aqueous electrolyte secondary battery to have high bonding strength between a current collector and an active material layer and a high battery capacity. Also, since Al is diffused at least on the current collector side of the positive electrode active material layer, the crystal structure of the positive electrode active material is stabilized, and the diffusion coefficient of Li ion is increased. As a result, the rate characteristics of the non-aqueous electrolyte secondary battery are improved. Even when the Al diffused into the active material layer is in the metal state, the conductivity is improved, and thus, good rate characteristics can be obtained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal sectional view schematically showing an exemplary deposition device;

FIG. 2 is a longitudinal sectional view schematically showing a coin-shaped non-aqueous electrolyte secondary battery; and

FIG. 3 is an electron micrograph of a section of a positive electrode for a non-aqueous electrolyte secondary battery according to an embodiment of the invention.

### DETAILED DESCRIPTION OF THE INVENTION

In a positive electrode for a non-aqueous electrolyte secondary battery according to the invention, Al is diffused at least on the current collector side of the positive electrode active material layer. In the vicinity of the interface between the current collector and the positive electrode active material layer, Al is diffused into the positive electrode active material layer to form a composite phase comprising an active material and Al. That is, a firm diffusion bond is formed between the current collector and the active material layer, thereby improving the bonding strength between the current collector and the positive electrode active material layer.

The positive electrode active material layer includes a composite oxide containing Li and a transition metal element Me. Al diffused from the current collector may be incorporated into the crystal structure of the composite oxide, or may be adherent in the metal state to the surfaces of the active material particles. The composite oxide may or may not contain Al as an element forming the crystal structure of the composite oxide (hereinafter may be referred to as a lattice element).

The region in which Al is diffused is preferably a diffusion region with a depth of 1 μm or less from the face of the positive electrode active material layer in contact with the current collector (hereinafter may be referred to as simply a diffusion region). In this case, deterioration of the current collector or a decrease in the battery capacity is effectively inhibited. If the region in which Al is diffused has a depth of more than 1 μm, the current collector may deteriorate, whereby the positive electrode active material layer tends to separate from the current collector. Also, the capacity of the positive electrode may decrease. Therefore, it is desirable that the region in which Al is diffused not have a depth of more than 1 μm from the face of the positive electrode active material layer in contact with the current collector.

The diffusion region preferably has a depth of 100 nm or more from the face of the positive electrode active material layer in contact with the current collector. If the diffusion region has a depth of less than 100 nm, the improvement in the bonding strength between the current collector and the positive electrode active material layer may be insufficient.

Thus, the amount of Al on the current collector side of the positive electrode active material layer is larger than the amount of Al on the surface side of the positive electrode active material layer. As used herein, the current collector side of the positive electrode active material layer refers to the part of the positive electrode active material layer whose thickness is less than 50% of the thickness of the positive electrode active material layer from the face (the first face) of the positive electrode active material layer in contact with the current collector. The surface side of the positive electrode active material layer, as used herein, refers to the part of the positive electrode active material layer whose thickness is equal to or less than 50% of the thickness of the positive electrode active material layer from the surface (the second face opposite to the first face) of the positive electrode active material layer.

The invention uses a thermal plasma to diffuse Al into the positive electrode active material layer from the current collector. Thus, one embodiment of the positive electrode active material layer is a film of a deposited composite oxide that is free from a binder such as a resin.

The thermal plasma potentially causes deterioration of a current collector due to high temperature. Hence, a current collector with a relatively high heat resistance, such as one made of stainless steel, is usually preferred to an Al-containing current collector. However, in the case of using an Al-containing current collector, by controlling the temperature of the current collector in a predetermined range and causing the Al to diffuse from the current collector into the positive electrode active material layer, the bonding strength between the current collector and the positive electrode active material layer is increased even when thermal plasma is used. Also, an active material layer produced in this manner has high crystallinity.

Further, Al is diffused at least on the current collector side of the positive electrode active material layer, thereby improving the rate characteristics of the non-aqueous electrolyte secondary battery. The Al diffused in the positive electrode active material layer is believed to stabilize the crystal structure of the positive electrode active material while increasing the diffusion coefficient of Li ion.

It is preferable that the amount of Al change in stages or continuously in the thickness direction of the positive electrode active material layer. That is, it is preferable that the amount of Al gradually decrease from the face of the positive electrode active material layer in contact with the current collector toward the surface of the positive electrode active material layer. The resulting Al concentration gradient serves to scatter the stress at the interface between the active material layer and the current collector, thereby increasing bonding strength. The amount of Al can decrease, on average, from the current collector side of the positive electrode active material layer toward the surface side, and the amount of Al may increase partially inside the positive electrode active material layer.

When the composite oxide does not contain Al as a lattice element, at least a part of the diffusion region preferably has an Al/Me atomic ratio of 0.01 or more and 0.5 or less, and more preferably has an Al/Me atomic ratio of 0.01 or more and 0.4 or less. In this case, deterioration of the current collector or a decrease in the battery capacity is effectively inhibited.

The amount of Al, the change in the amount of Al, and the Al/Me ratio in the thickness direction of the positive electrode active material layer can be determined, for example, by energy-dispersive X-ray spectroscopy (EDAX), ESCA (XPS, Auger electron spectroscopy), EPMA, and ICP analysis. These methods allow quantitative analyses of elements in micro-regions. Thus, regardless of the surface roughness of the current collector, the face of the positive electrode active material layer in contact with the current collector can be identified. If the diffusion of Al in a region with a depth of 1 μm from the face of the positive electrode active material layer in contact with the current collector can be identified by any of these methods, the advantageous effects of the invention can be obtained more effectively. Also, if the Al/Me ratio in this region is 0.01 or more, the advantageous effects of the invention can be obtained in a more reliable manner.

The positive electrode active material layer includes a composite oxide containing Li and one or more transition metal elements Me (hereinafter may be referred to as simply a composite oxide) as a positive electrode active material. The composite oxide preferably has a layered or hexagonal crystal structure, a spinel structure, or an olivine structure. Examples of transition metal elements Me include Co, Ni, Mn, Ti, and Fe. The composite oxide may contain these transition metal elements singly or in combination. The composite oxide may contain one or more metalloid elements such as P, As, and Sb.

Examples of such composite oxides include LiCoO₂, LiNi_{1/2}Mn_{1/2}O₂, LiNi_{1/2}Co_{1/2}O₂, LiNiO₂, LiNi_{1/3}Mn_{1/3}CO_{1/3}O₂, LiNi_{1/2}Fe_{1/2}O₂, LiMn₂O₄, LiFePO₄, LiCoPO₄, LiMnPO₄, and Li_{4/3}Ti_{5/3}O₄. Among them, LiCoO₂ or LiNiO₂ is preferable since it has high discharge capacity and its crystal structure can be stabilized effectively due to the diffusion of Al.

When the composite oxide contains Co as the transition metal element Me, diffusing Al in the positive electrode active material layer can further increase the diffusion coefficient of Li ion. Thus, even when the packing rate of the positive electrode active material layer is heightened, the rate characteristics can be maintained. Co-containing composite oxides are represented by, for example, the general formula: LiₓM¹_{y}CO_{1-y}O_{2±a} wherein M¹ is at least one selected from the group consisting of Ni, Mn, and Fe, 0.9≦x≦1.3, 0<y≦0.5, and 0≦a≦0.2.

Also, when the composite oxide contains Ni as the transition metal element Me, diffusing Al in the positive electrode active material layer can further stabilize the crystal structure of the positive electrode active material. Ni-containing composite oxides are represented by, for example, the general formula: LiₓM²_{y}Ni_{1-y}O_{2±a} wherein M² is at least one selected from the group consisting of Co, Mn, and Fe, 0.9≦x≦1.3, 0<y≦0.5, and 0≦a≦0.2.

The composite oxide with a layered or hexagonal crystal structure or a spinel structure may contain Al. Al-containing composite oxides with a layered or hexagonal crystal structure are represented by, for example, the general formula: LiₓMe_{1-y}Al_{y}O_{2±a} wherein Me is at least one selected from the group consisting of Co, Ni, Mn, and Fe, 0.9≦x≦1.3, 0.01≦y≦0.1, and 0≦a≦0.2. In particular, Me in such an Al-containing composite oxide preferably includes at least Ni and Co. Such composite oxides are represented by the general formula: LiₓNi_{y}CO_{z}Al_{w}M³_{1-y-z-w}O_{2±a} wherein M³ is at least one selected from the group consisting of Mn and Fe, 0.9≦x≦1.3, 0.7≦y≦0.85, 0.1≦z≦0.2, 0.01≦w≦0.1, y+z+w≦1, and 0≦a≦0.2.

The porosity of the positive electrode active material layer is preferably, for example, 3 to 15%. According to the invention, since Al is diffused into the positive electrode active material layer, even if the porosity is relatively small, good rate characteristics can be maintained.

The current collector includes Al. When a positive electrode active material layer is formed on an Al-containing current collector by a predetermined method, a sufficient amount of Al diffuses into the positive electrode active material layer, thereby increasing the bonding strength between the current collector and the positive electrode active material layer. Also, the crystallinity of the active material is heightened, and a high capacity can be obtained. The current collector may be made of Al simple substance or an alloy containing Al and other element(s). Specifically, the alloy may be an Al—Co alloy, an Al—Ni alloy, or the like.

In terms of promoting the diffusion of Al into the positive electrode active material layer, the surface roughness Ra of the current collector is preferably 0.01 to 1 μm, and more preferably 0.01 to 0.5 μm. Also, the current collector may be subjected to a surface treatment such as plating, surface roughening, or etching.

Next, a preferable method for producing a positive electrode for a non-aqueous electrolyte secondary battery will be described.

The production method includes: (a) generating a thermal plasma in a predetermined atmosphere; (b) supplying a raw material of an active material into the thermal plasma; (c) producing active material particles from the raw material in the thermal plasma; and (d) depositing the active material particles produced in the thermal plasma onto a surface of a current collector in the predetermined atmosphere to form an active material layer.

The pressure of the predetermined atmosphere is preferably 10² to 10⁶ Pa.

It is thought that the particles produced in the thermal plasma are cooled near the current collector and partially bound together to form nano-size clusters. Since the particles produced in the thermal plasma have large energy, when such particles are deposited on the current collector, the diffusion of Al contained in the current collector into the positive electrode active material layer is promoted. Therefore, a positive electrode for a non-aqueous electrolyte secondary battery in which Al is diffused at least on the current collector side of the positive electrode active material layer can be produced without requiring complicated steps, and the production cost can be reduced.

When an active material layer is formed by depositing an active material by a conventional production method such as vapor deposition, Al contained in a current collector is unlikely to diffuse into the positive electrode active material layer since the active material particles have small energy.

A thermal plasma refers to a kind of plasma in which electrons, ions, and neutral particles have high thermal energy. The electrons, ions, and neutral particles contained in a thermal plasma have high temperature and almost the same temperature. The temperature of the electrons, ions, and neutral particles in the hottest portion is, for example, 10000 to 20000K.

Examples of methods for generating a thermal plasma include, but are not particularly limited to, a method using a direct current arc discharge, a method using a high frequency electromagnetic field, and a method using micro waves. Among them, the method using a high frequency electromagnetic field is preferable. It is preferable to generate a thermal plasma in an atmosphere whose pressure is close to atmospheric pressure (e.g., 10⁴ to 10⁶ Pa).

A low-temperature plasma is generated at a low pressure (e.g., 10¹ Pa or less). In a low-temperature plasma, only the electrons have a high temperature, whereas the ions and neutral particles have low temperatures. A low-temperature plasma is used, for example, in sputtering.

An example of a deposition device using a high frequency electromagnetic field is described with reference to a drawing.

FIG. 1 is a longitudinal sectional view schematically showing a deposition device. The deposition device includes a chamber 1, where deposition is performed, and a thermal plasma source. The thermal plasma source includes a torch 10, where plasma is generated, and an induction coil 2 around the torch 10. The induction coil 2 is connected to a power source 9.

The chamber 1 may or may not be equipped with a vacuum pump 5. When the air remaining in the chamber 1 is removed by the vacuum pump 5 before a thermal plasma is generated, contamination of the active material can be suppressed. The vacuum pump 5 makes it easy to control the shape of the gas stream in the plasma and the deposition conditions such as the pressure inside the chamber 1. The chamber 1 may be equipped with, for example, a filter (not shown) for catching dust particles.

A stage 3 is disposed vertically below the torch 10. While the material of the stage 3 is not particularly limited, a highly heat-resistant material is preferable, and such examples include stainless steel. An Al-containing current collector 4 is placed on the stage 3. The stage 3 is equipped with a heater and a cooling device (not shown) for controlling the temperature of the current collector.

One end of the torch 10 is open toward the chamber 1. In the case of using a high frequency voltage, the torch 10 is preferably made of a material having good heat resistance and a good insulating property, such as ceramics (e.g., quartz or silicon nitride). The inner diameter of the torch 10 is not particularly limited. When the inner diameter of the torch is increased, the reaction site can be enlarged, and thus, an active material layer can be formed efficiently.

The other end of the torch 10 is provided with a gas supply port 11 and a raw material supply port 12. The gas supply port 11 is connected with gas supply sources 6a and 6b via valves 7a and 7b, respectively. The raw material supply port 12 is connected with a raw material supply source 8. By supplying gases to the torch 10 from the gas supply port 11, a thermal plasma can be efficiently generated.

In terms of stabilizing the thermal plasma and controlling the gas stream in the thermal plasma, a plurality of the gas supply ports 11 may be provided. In the case of providing a plurality of the gas supply ports 11, the direction from which a gas is introduced is not particularly limited, and the gas may be introduced, for example, from the axial direction of the torch 10 or the direction perpendicular to the axial direction of the torch 10. The ratio of the amount of gas introduced from the axial direction of the torch 10 to the amount of gas introduced from the direction perpendicular to the axial direction of the torch 10 is preferably 100:0 to 10:90. As the amount of gas introduced from the axial direction of the torch 10 becomes larger, the gas stream inside the thermal plasma becomes thinner and the temperature of the central part of the gas stream becomes higher, which promotes vaporization and decomposition of the raw material. In terms of stabilizing the thermal plasma, it is preferable to control the amount of gas introduced by using, for example, a massflow controller (not shown).

When a voltage is applied from the power source 9 to the induction coil 2, a thermal plasma is generated in the torch 10. The voltage applied may be a high frequency voltage or direct current voltage. Also, a high frequency voltage and a direct current voltage may be used in combination. In the case of using a high frequency voltage, its frequency is preferably 1000 Hz or more. While the material of the induction coil 2 is not particularly limited, a low resistance metal such as copper can be used.

In generating a thermal plasma, the induction coil 2 and the torch 10 become hot. It is thus preferable to provide a cooling device (not shown) around the induction coil 2 and the torch 10. For example, a water cooling device may be used as the cooling device.

The steps (a) to (d) are described.

### (1) Step (a)

In the step (a), a thermal plasma is generated. It is preferable to generate a thermal plasma in an atmosphere containing at least one gas selected from the group consisting of argon, helium, oxygen, hydrogen, and nitrogen. In terms of generating a thermal plasma stably and efficiently, it is more preferable to generate a thermal plasma in an atmosphere containing diatomic molecules such as hydrogen. In the case of using a reactive gas such as oxygen, hydrogen, nitrogen, or an organic gas and an inert gas such as a rare gas in combination, the reaction between a raw material and the reactive gas may be utilized to produce an active material.

In the case of using a high frequency electromagnetic field, a thermal plasma is generated by applying a high frequency to a coil from an RF power source. The frequency of the power source is preferably, for example, 1000 Hz or more, and is, for example, 13.56 MHz. In the case of utilizing high frequency induction heating, which requires no electrode, no contamination of the active material by an electrode occurs. Thus, a positive electrode with good charge/discharge characteristics can be obtained.

When a deposition device as illustrated in FIG. 1 is used to generate a plasma by direct current arc discharge, the speed of gas jetted from the gas supply port is lower than several thousands of m/s, and can be approximately several tens of m/s to several hundreds of m/s, for example, 900 m/s or less. In this case, the residence time of the raw material in the thermal plasma can be made relatively long, and the raw material can be fully dissolved, vaporized, or decomposed in the thermal plasma. Thus, an active material can be synthesized and deposited on a current collector efficiently.

It is preferable to raise the temperature of the current collector to 300 to 400° C. by using a heater or the like before the thermal plasma is generated. This promotes the diffusion of Al into the current collector side of the positive electrode active material layer, thereby increasing the bonding strength between the current collector and the positive electrode active material layer. Also, the crystallinity of the active material is heightened, and a good capacity can be obtained.

### (2) Steps (b) and (c)

In the step (b), a raw material for an active material layer is supplied into the thermal plasma. As a result, particles serving as a precursor of an active material are produced in the thermal plasma (step (c)). When two or more raw materials are used, they may be supplied into the thermal plasma separately, but they are preferably mixed sufficiently before being supplied into the thermal plasma.

The raw material supplied into the thermal plasma may be in liquid form or in powder form. However, supplying a raw material in powder form into the thermal plasma is easier and more advantageous in terms of production costs. Raw materials in powder form are relatively inexpensive, compared with raw materials in liquid form, such as alkoxides.

In the case of supplying a raw material in liquid form into the thermal plasma, the removal of impurities such as solvent and carbon may become necessary. On the other hand, In the case of supplying a raw material in powder form into the thermal plasma, since the raw material contains almost no such impurities, a positive electrode with good electrochemical characteristics can be obtained.

When a raw material in powder form is supplied into the thermal plasma, the volume basis median diameter (D50) of the raw material is preferably less than 20 μm. If the median diameter of the raw material exceeds 20 μm or more, the raw material may not be sufficiently vaporized or decomposed in the thermal plasma, so the formation of an active material may be hindered.

While the speed at which the raw material is supplied into the thermal plasma varies according to the volume of the device, the plasma temperature, etc., it is preferably, for example, 0.0002 to 0.05 g/min per kilowatt of the output of the high frequency voltage applied to the induction coil.

If the speed at which the raw material is supplied into the thermal plasma exceeds 0.05 g/min per kilowatt of the output of the high frequency voltage applied to the induction coil, Al may not sufficiently diffuse at least on the current collector side of the positive electrode active material layer, so the bonding strength between the positive electrode active material layer and the current collector may become low.

If the speed at which the raw material is supplied into the thermal plasma is less than 0.001 g/min per kilowatt of the output of the high frequency voltage applied to the induction coil, the thermal plasma loses only a small amount of energy as the heat of melting of the raw material. As such, the thermal plasma maintaining higher energy can dissolve, vaporize, or decompose the raw material more effectively. The decomposed raw material reaches the vicinity of the current collector surface while being irradiated with the high energy thermal plasma, and an active material is synthesized therefrom and deposited on the current collector surface. At this time, since the particles deposited on the current collector surface have high energy, the diffusion of Al into the positive electrode active material layer is promoted.

Various materials can be used as raw materials for an active material, and examples include (i) a raw material including a lithium compound and a compound containing one or more transition metal elements Me; and (ii) a raw material including a composite oxide containing Li and one or more transition metal elements Me.

Examples of lithium compounds include lithium oxide, lithium hydroxide, lithium carbonate, and lithium nitrate. They may be used singly or in combination.

Examples of compounds containing one or more transition metal elements Me include nickel compounds, cobalt compounds, manganese compounds, and iron compounds. They may be used singly or in combination. Examples of nickel compounds include nickel oxide, nickel carbonate, nickel nitrate, nickel hydroxide, and nickel oxyhydroxide. Examples of cobalt compounds include cobalt oxide, cobalt carbonate, cobalt nitrate, and cobalt hydroxide. Examples of manganese compounds include manganese oxide and manganese carbonate. Examples of iron compounds include iron oxide and iron carbonate.

When Al is added to a composite oxide serving as the positive electrode active material, an aluminum compound can be used as a raw material for the active material in addition to a lithium compound and a compound containing one or more transition metal elements Me. Examples of aluminum compounds include aluminum nitrate, aluminum hydroxide, aluminum sulfate, and aluminum oxide.

For example, to form a positive electrode active material layer including a composite oxide, a lithium compound and a compound containing one or more transition metals are supplied into the thermal plasma as raw materials for the active material. Although these compounds can be separately supplied into the thermal plasma, it is preferable to sufficiently mix them before supplying them into the thermal plasma.

Since the evaporation of lithium is promoted in the thermal plasma, it is preferable to make the mixing ratio of the lithium compound to the raw materials higher than the stoichiometric lithium ratio of the intended active material.

Examples of combinations of raw materials are given below.

To form an active material layer including LiCoO₂, it is preferable to use a lithium compound and a cobalt compound as raw materials for the active material.

To form an active material layer including LiₓNi_{y}CO_{1-y}O_{2±a}, it is preferable to use a lithium compound, a cobalt compound, and a nickel compound as raw materials for the active material.

To form an active material layer including LiₓNi_{y}Mn₁₋O_{2±a}, it is preferable to use a lithium compound, a manganese compound, and a nickel compound as raw materials for the active material.

To form an active material layer including LiₓNi_{y}Fe_{1-y}O_{2±a}, it is preferable to use a lithium compound, a nickel compound, and an iron compound as raw materials for the active material.

To form an active material layer including LiₓNi_{y}CO_{z}Al_{w}O_{2±a}, it is preferable to use a lithium compound, a nickel compound, a cobalt compound, and an aluminum compound as raw materials for the active material.

A composite oxide containing Li and one or more transition metal elements Me (an active material itself) may be used as the raw material. A composite oxide containing Li and one or more transition metal elements Me supplied into the thermal plasma is dissolved, vaporized, or decomposed and re-synthesized to be deposited on a current collector.

### (3) Step (d)

The particles produced in the thermal plasma are supplied from the direction substantially perpendicular to the surface of the current collector and deposited on the current collector to form a positive electrode active material layer. Since the particles produced in the thermal plasma have large energy, Al diffuses into the positive electrode active material layer at the interface between the current collector and the positive electrode active material layer. As a result, a composite phase comprising an active material and Al is formed.

In the step (d), by adjusting the temperature of the atmosphere near the current collector, the structure of the active material layer can be controlled. In the step (d), when the temperature of the current collector is controlled at 450° C. or more and less than 600° C., a sufficient amount of Al can be diffused at least on the current collector side of the positive electrode active material layer, and the crystallinity of the active material can be sufficiently heightened. If the temperature of the current collector is lower than 450° C., the crystallinity of the active material becomes insufficient, and good charge/discharge characteristics cannot be obtained. Also, Al does not sufficiently diffuse into the active material layer, and the bonding strength between the current collector and the active material layer is not increased. On the other hand, if the temperature of the current collector exceeds 600° C., the current collector deteriorates significantly, so the conductivity of the current collector becomes insufficient.

While the method for controlling the temperature of the atmosphere near the current collector is not particularly limited, it can be controlled, for example, by adjusting the distance between the torch and the current collector, the shape of the gas stream in the thermal plasma, the output of the high frequency voltage applied to the induction coil, and the cooling device. As the distance between the current collector and the torch becomes shorter, the temperature of the atmosphere near the current collector becomes higher. As the flow rate of gas in the axial direction of the torch is increased, the temperature of the atmosphere near the current collector becomes higher. Further, as the output of the high frequency voltage applied to the induction coil is increased, the temperature of the atmosphere near the current collector becomes higher. Also, the temperature of the current collector may be controlled by using a cooling device for cooling the current collector as described above.

### EXAMPLES

The invention is hereinafter described more specifically by way of examples and comparative examples. These examples and comparative examples, however, are not to be construed as limiting in any way the invention.

### Example 1

### (1) Preparation of Positive Electrode

A high-frequency induction thermal plasma generator (TP-12010 available from Japan Electron Optics Laboratory Co., Ltd.), equipped with a chamber with an internal volume of 6250 cm³ and a thermal plasma source, was used as a deposition device. The thermal plasma source included a torch comprising a silicon nitride tube with a diameter of 42 mm and a copper induction coil around the torch.

A stage was installed at a position inside the chamber which was 345 mm below the lower end of the torch. A current collector (thickness 0.2 mm) comprising an aluminum foil (Ra=0.08 μm) was mounted on the stage. Then, the air inside the chamber was replaced with argon gas.

Argon gas was introduced into the chamber at a flow rate of 40 L/min, while oxygen gas was introduced at a flow rate of 20 L/min. The pressure inside the chamber was set to 150 Torr (approximately 20 kPa). The temperature of the current collector was set to 300° C. Thereafter, a high frequency voltage of 42 kW with a frequency of 3.5 MHz was applied to the induction coil to generate a thermal plasma.

A mixture of Li₂CO₃ powder and CO₃O₄ powder was used as the raw material for an active material. Argon gas and oxygen gas were introduced into one flow path at 40 L/min and 20 L/min, respectively, and the resulting mixed gas was introduced into the chamber from two directions. The ratio of the amount Dₓ of gas introduced from the direction substantially perpendicular to the axial direction of the torch to the amount D_{y} of gas introduced from the axial direction of the torch (hereinafter referred to as Dₓ:D_{y}) was set to 40:60. With the supply speed of the raw material to the thermal plasma set to 0.06 g/min, deposition was performed for 60 minutes, so that a positive electrode active material layer was formed on the current collector. The thickness of the positive electrode active material layer was made 2 μm. The temperature of the current collector during the deposition was 510° C.

The amount of Al was measured by the following method.

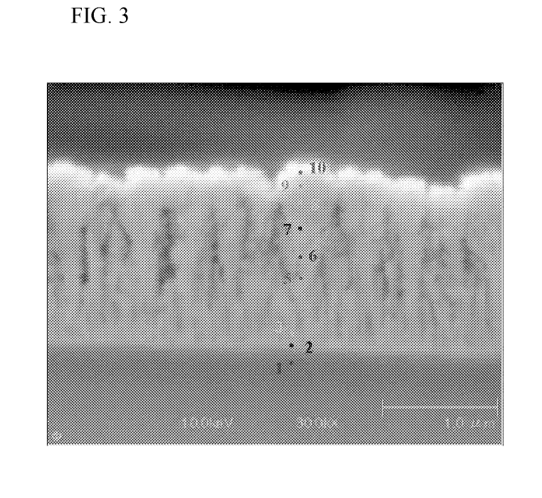

Using a focused ion beam (FIB), the positive electrode was etched to obtain a section, and Co and Al were measured by EDAX and Auger photoelectron spectroscopy. At this time, a region with a depth of 2 μm from the face of the positive electrode active material layer in contact with the current collector was measured. FIG. 3 shows an electron micrograph of the section of the positive electrode. The numerical figures in the center of the micrograph represent the points subjected to the Auger photoelectron spectroscopic analysis.

As a result, the diffusion of Al was confirmed in a region with a depth of 100 nm or more. Also, at a depth of 200 nm, the atomic ratio of Al to Co (Al/Co) was 0.01.

However, at a depth of more than 1 μm from the face of the positive electrode active material layer in contact with the current collector, Al was not identified. Also, the active material was scrapped from a region with a depth of approximately 1 μm from the surface of the active material layer, and was subjected to an ICP analysis. As a result, no Al was detected.

The ICP analysis of the active material layer confirmed that the elemental ratio was Li:Co=1.2:1 (molar ratio). In the ICP analysis, first, the absolute amounts of Li and Co were obtained, and the compositional ratio of Li to Co was calculated from the absolute amounts on the assumption that all the Co was present as LiCoO₂.

### (2) Preparation of Non-Aqueous Electrolyte

A non-aqueous electrolyte was prepared by dissolving LiPF₆ (solute) at a concentration of 1.25 mol/L in a non-aqueous solvent. The non-aqueous solvent was a liquid mixture of ethylene carbonate (EC) and ethyl methyl carbonate (EMC) in a volume ratio of 1:3.

### (3) Production of Battery

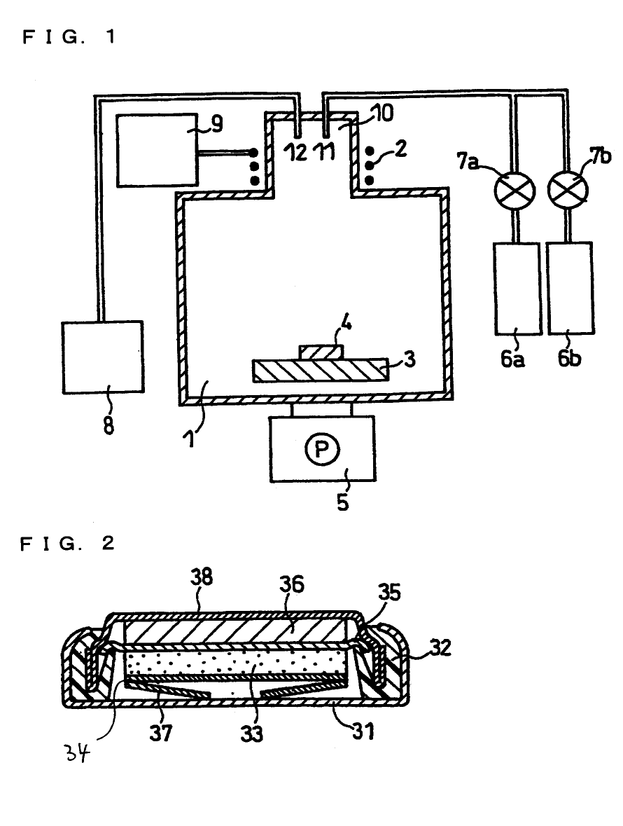

A coin-shaped non-aqueous electrolyte secondary battery as illustrated in FIG. 2 was produced. A 0.3-mm thick lithium foil was affixed to the inner face of a seal plate 38 as a negative electrode 36, and a porous insulating layer 35 was disposed thereon. A positive electrode 33, prepared in the above manner, was then disposed on the porous insulating layer 35 so that the positive electrode active material layer faced the porous insulating layer 35. A disc spring 37 was disposed on the positive electrode current collector 34. The non-aqueous electrolyte was injected so as to fill the seal plate 38, and a case 31 was engaged with the seal plate 38 with a gasket 32 therebetween, to produce a test coin battery.

### Comparative Example 1

A positive electrode was produced in the same manner as in Example 1, except for the use of a gold foil (Ra=0.1 μm) instead of the aluminum foil. The positive electrode was measured to detect the diffusion of Au in the same manner as described above. As a result, the diffusion of Au was not identified at a depth of 100 nm from the face of the positive electrode active material layer in contact with the current collector. A coin battery was produced in the same manner as in Example 1 except for the use of the positive electrode thus produced.

### Comparative Example 2

A positive electrode was produced in the same manner as in Example 1, except that the temperature of the current collector during deposition was set to 440° C. The positive electrode was measured to determine the amount of Al. As a result, the diffusion of Al was not identified at a depth of 100 nm from the face of the positive electrode active material layer in contact with the current collector. A coin battery was produced in the same manner as in Example 1 except for the use of the positive electrode thus produced.

The batteries of Example 1 and Comparative Examples 1 and 2 were charged and discharged. Specifically, they were charged and discharged in the range of 3.05 to 4.25 V with respect to Li/Li⁺, and the initial discharge capacity (the discharge capacity at the 1^{st} cycle) and the discharge capacity at the 10^{th} cycle at 0.2 C were measured. The temperature condition was set to 20° C. The results are shown in Table 1.

TABLE 1

| | Discharge capacity | Discharge capacity |
|---|---|---|
| | at 1^{st} cycle (mAh/g) | at 10^{th} cycle (mAh/g) |
| Example 1 | 148 | 145 |
| Comp. Example 1 | 146 | 134 |
| Comp. Example 2 | 30 | 16 |

Compared with Comparative Example 1, the discharge capacity of Example 1 was improved. This is probably because Al diffused from the current collector, thereby increasing the bonding strength between the positive electrode active material layer and the current collector and suppressing the separation of the positive electrode active material layer from the current collector. On the other hand, Comparative Example 2 did not provide a sufficient discharge capacity. This is probably because the diffusion of Al and the crystallinity of the active material were insufficient.

The positive electrodes of Example 1 and Comparative Example 2 were subjected to an XRD analysis, and the result confirmed that these positive electrodes included LiCoO₂ with a crystal structure belonging to the space group R-3m as the positive electrode active material. However, compared with the intensity of the peak attributed to the (003) plane of the positive electrode of Example 1, the peak intensity of Comparative Example 2 was less than 1/10. Also, in a comparison of the full width at half maximum (FWHM), the FWHM of Comparative Example 2 was greater than the FWHM of Example 1. This indicates that the active material of Example 1 has high crystallinity.

In the foregoing Examples, LiCoO₂ was used as the positive electrode active material. However, the use of a composite oxide including Li and Me and having a layered or hexagonal crystal structure, such as LiNi_{0.8}CO_{0.17}Al_{0.03}O₂, is thought to produce essentially the same effects, since it has a similar structure and allows similar temperature control.

The use of a positive electrode for a non-aqueous electrolyte secondary battery according to the invention can provide a non-aqueous electrolyte secondary battery having high bonding strength between the current collector and the active material layer and a high battery capacity. This non-aqueous electrolyte secondary battery is useful as the power source for portable electronic devices such as cellular phones, large-sized electronic devices, etc.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A positive electrode for a non-aqueous electrolyte secondary battery, comprising:
a current collector including Al; and
a positive electrode active material layer adhering to the current collector,
wherein the positive electrode active material layer includes a composite oxide containing Li and a transition metal element Me, and
the positive electrode active material layer has, at least on the current collector side, a region in which Al is diffused from the current collector.

2. The positive electrode for a non-aqueous electrolyte secondary battery in accordance with claim 1, wherein the region in which Al is diffused has a depth of 1 μm or less from the face of the positive electrode active material layer in contact with the current collector.

3. The positive electrode for a non-aqueous electrolyte secondary battery in accordance with claim 2, wherein the region in which Al is diffused has a depth of 100 nm or more from the face of the positive electrode active material layer in contact with the current collector.

4. The positive electrode for a non-aqueous electrolyte secondary battery in accordance with claim 1, wherein the amount of the Al changes in stages in the thickness direction of the positive electrode active material layer.

5. The positive electrode for a non-aqueous electrolyte secondary battery in accordance with claim 1, wherein the amount of the Al changes continuously in the thickness direction of the positive electrode active material layer.

6. The positive electrode for a non-aqueous electrolyte secondary battery in accordance with claim 1,
wherein the composite oxide does not contain Al, and
at least a part of the region in which Al is diffused has an Al/Me atomic ratio of 0.01 or more and 0.5 or less.

7. A method for producing a positive electrode for a non-aqueous electrolyte secondary battery, comprising the steps of:
(a) generating a thermal plasma in a predetermined atmosphere;
(b) supplying a raw material of an active material into the thermal plasma;
(c) producing active material particles from the raw material in the thermal plasma; and
(d) depositing the active material particles produced in the thermal plasma onto a surface of a current collector in the predetermined atmosphere to form an active material layer,
wherein the raw material includes Li and a transition metal element Me,
the current collector includes Al, and
the temperature of the current collector in the step (d) is controlled at 450° C. or more and less than 600° C.

8. The method for producing a positive electrode for a non-aqueous electrolyte secondary battery in accordance with claim 7, wherein the step (b) comprises supplying the raw material in powder form into the thermal plasma.

9. The method for producing a positive electrode for a non-aqueous electrolyte secondary battery in accordance with claim 8, wherein the raw material includes a lithium compound and a compound containing the transition metal element Me.

10. The method for producing a positive electrode for a non-aqueous electrolyte secondary battery in accordance with claim 8, wherein the raw material includes a composite oxide containing Li and the transition metal element Me.
